(19) United States
(12) Patent Application Publication
(10) Pub. No.: US 2011/0075840 A1
(43) Pub. Date: Mar. 31, 2011

(54) METHOD AND SYSTEM FOR GENERATING RANDOM NUMBERS IN A STORAGE DEVICE

(76) Inventors: Fernando A. Zayas, Loveland, CO (US); Richard M. Ehrlich, Saratoga, CA (US)

(21) Appl. No.: 12/571,311

(22) Filed: Sep. 30, 2009

(51) Int. Cl. H04L 9/00; G06F 7/58

(52) U.S. Cl. 380/46; 708/250

(57) ABSTRACT

Random numbers are generated in a storage device based on the parity bits of successive position error signal (PES) samples. The parity bits of multiple PES samples are concatenated to form a random number having a desired number of bits. The random number may be further randomized by being processed with a deterministic random bit generator (DRBG) included in the firmware of the storage device.

### BACKGROUND OF THE INVENTION

1. Field of the Invention

Embodiments of the present invention relate generally to storage devices and, more particularly, to a method and system for generating random numbers in storage devices.

2. Description of the Related Art

In computing, random numbers are used in various applications, including encryption and decryption algorithms. In both symmetric and asymmetric cryptography, random numbers allow the generation of encryption keys for establishing secure communication between a host and an encrypted disk drive. Since integrity of the communication between the two parties is conditional on the continued secrecy of such encryption keys, using a random number generator that does not have sufficient randomness may compromise the security of such communication. Different means are known in the art for generating the random numbers in a disk drive for use in drives encryption and decryption algorithms, including deterministic random bit generators, hardware random number generators, and methods that convert disk drive parameters or environmental noise to random numbers.

A deterministic random bit generator (DRBG), also referred to as a pseudo-random number generator, is an algorithm for generating a sequence of numbers that approximates the properties of random numbers. Such a sequence is not truly random in that the output of the algorithm is deterministic, i.e., completely determined by a relatively small set of initial values referred to as the DRBG's state. Because numbers generated by a DRBG are deterministic, they may not be sufficiently “random” to suit the intended use—particularly for encryption and decryption algorithms. In addition, if the random seed used to initialize a DRBG is discovered, a key that is pseudo-randomly generated by the DRBG can be determined. Therefore, DRBGs are not ideal for use in connection with applications requiring high quality real random numbers.

A hardware random number generator is an apparatus that generates random numbers from a physical process. Such devices are often based on microscopic phenomena including thermal noise, the photoelectric effect, or other quantum phenomena. Such processes are, in theory, completely unpredictable, and therefore can be used as a source of entropy, i.e., randomness, for the generation of random numbers. However, accurately constructing robust hardware random number generators is problematic. The failure modes in such devices are numerous, complex, and difficult to detect. For example, most hardware random number generator designs are both fragile and known to fail “silently,” that is, with no way of measuring the failure directly, often producing decreasingly random numbers as the device degrades. Thus, without performing continuous statistical tests on the output of a hardware random number generator, such a device can be an unreliable source of truly random numbers. Further, the use of such hardware entails additional costs to the computer user, requiring specialized circuitry and other hardware not normally provided as part of a computer.

Methods are also known in the art for converting disk drive parameters or environmental noise to random numbers. U.S. Pat. No. 7,136,889, for example, describes observing one or more disk drive parameters in a disk drive and using the measured parameters or combinations of the measured parameters as random numbers. Observable disk drive parameters suitable for producing random numbers include position error signal (PES) of a transducer head relative to a selected track, fly-height of a transducer head over a disk, and temperature of the disk drive, among others. However, in order for such a method to produce random numbers at a useful rate for encryption and other applications, dedicated hardware, such as registers and logic gates, may need to be added to the circuitry of the disk drive, increasing the cost and complexity of the disk drive.

### SUMMARY OF THE INVENTION

One or more embodiments of the present invention provide a method and system for generating and managing random numbers in a storage device, wherein the parity bits of successive position error signal samples are concatenated to quickly form a random number having a desired number of bits. The random number may be further randomized by being processed with a deterministic random bit generator included in the firmware of the storage device.

In one embodiment, a method of generating one or more random numbers in a storage device comprises concatenating parity bits from a group of different position error signal samples to produce a random number. The random number is then supplied as entropy to a deterministic random number generator to produce a second random number. The second random number may be used by an application of the storage device or a host connected to the storage device.

In another embodiment, random numbers are generated in a storage device in a manner that complies with the self-test requirement and require random numbers that are used by applications not to be stored for a prolonged period of time. The method according to this embodiment employs two buffers. The first buffer stores the previous output of a deterministic random number generator. The second buffer is provided by applications to accept the resulting random number. The method includes the steps of copying the first buffer to the second buffer, generating a first random number and storing it in the first buffer, comparing the first random number with a random number that is stored in the second buffer to comply with the self-test requirement, copying the first random number to the second buffer so that it can be used by the application, and generating another random number to overwrite the first random number stored in the first buffer. The management of the second buffer (for example, to be used as a key) is left to the application. It is standard practice in applications to use the random number and then zeroize this buffer.

A storage device according to an embodiment of the present invention comprises a deterministic random number generator configured to receive N1 bits of entropy inputs and generate N2 bits of random numbers therefrom, wherein N1 equals N2, and some of the N2 bits of random numbers are used by an application within the storage device. The storage device may further include a second deterministic random number generator configured to generate a third random number for use by an application on a host connected to the storage device. The two deterministic random number generators are configured differently so that observation of the random numbers generated for the host do not expose any deficiencies used to generate the random numbers used by the storage device internally.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a disk drive that may be configured to generate random numbers, according to embodiments of the invention.

FIG. 2 illustrates magnetic disk with data organized in a typical manner known in the art.

FIG. 3 is a block diagram schematically illustrating components of the printed circuit board in FIG. 1.

FIG. 4 is a flow diagram illustrating a method, according to an embodiment of the invention, for generating a random number in a disk drive for use by an application of the disk drive or a host.

FIG. 5 is a block diagram conceptually illustrating random number generation according to one or more embodiments of the present invention.

For clarity, identical reference numbers have been used, where applicable, to designate identical elements that are common between figures. It is contemplated that features of one embodiment may be incorporated in other embodiments without further recitation.

### DETAILED DESCRIPTION

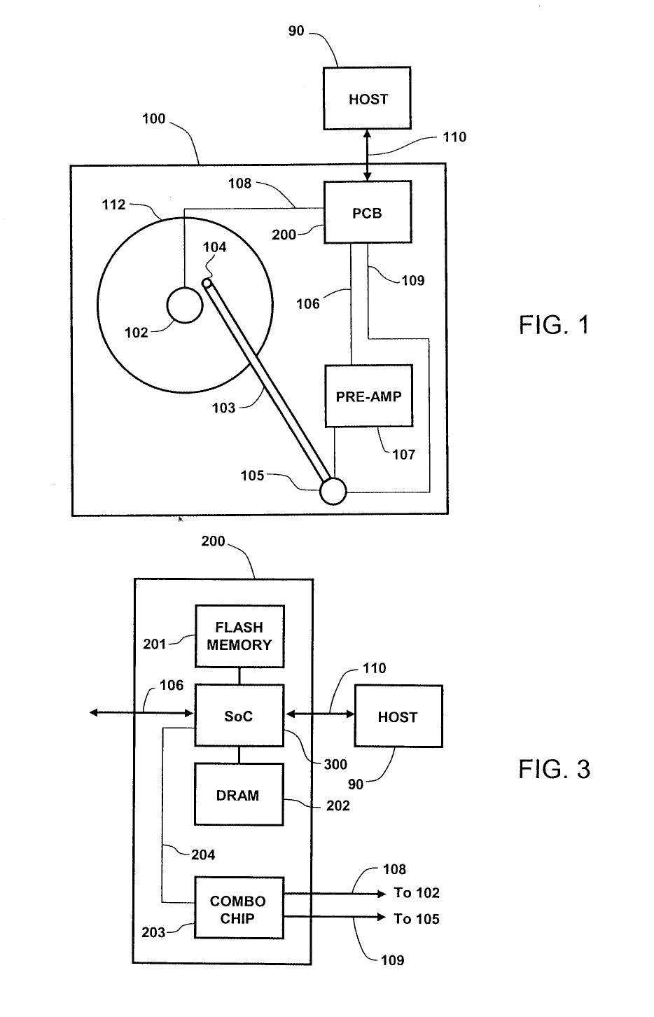

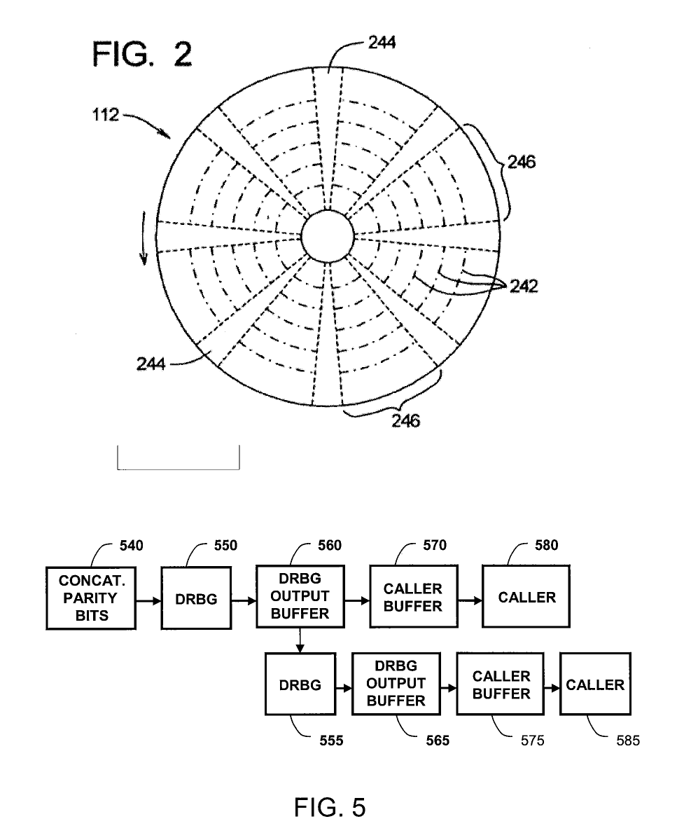

FIG. 1 is a block diagram illustrating a disk drive 100 that may be configured to generate random numbers, according to one or more embodiments of the invention. The mechanical components of disk drive 100 include a magnetic disk 112 rotated by a spindle motor 102, a read/write head 104 disposed on the end of a suspension arm 103. Arm actuator 105 is coupled to suspension arm 103 for moving arm 103 as desired to access different tracks of magnetic disk 112. Electronic components of disk drive 100 include a printed circuit board, PCB 200, and a pre-amplifier 107, the latter of which is electrically coupled to read/write head 104. Pre-amplifier 107 conditions and amplifies signals to and from read/write head 104. PCB 200 includes a system-on-chip (SoC), RAM, and other integrated circuits for operating disk drive 100, and is described below in conjunction with FIG. 3. As shown, PCB 200 is electrically coupled to pre-amplifier 107 via electrical connection 106, to spindle motor 102 via electrical connection 108, and to arm actuator 105 via electrical connection 109. PCB 200 communicates with a host 90 via cable 110, which may be an SATA, PATA, SCSI, or other interface. Host 90 may be a laptop computer, a desktop computer, or an appliance such as set-top boxes, televisions and video players, requesting access to one or more sectors of an encryption-enabled storage device contained in the computer or a remote computing device accessing the storage device over a LAN or WAN.

FIG. 2 illustrates magnetic disk 112 with data organized in a typical manner known in the art. Magnetic disk 112 includes a plurality of concentric data storage tracks 242, each of which includes a plurality of servo wedges 244 and data fields 246. Each of concentric data storage tracks 242 is schematically illustrated as a centerline. However, it should be understood that each of concentric data storage tracks 242 occupies a finite width about a corresponding centerline. Magnetic disk 112 includes substantially radially aligned servo wedges 244, also referred to as servo spokes, that cross concentric data storage tracks 242 and store servo information in servo sectors in concentric data storage tracks 242. Such servo information includes a reference signal, such as a square wave of known amplitude, that is read by transducer head 121 during read and write operations to position the transducer head 121 above a desired track 242. The various possible configurations of the servo information in servo wedges 244 are known in the art and are not detailed herein. Typically, the actual number of concentric data storage tracks 242 and servo spokes 244 included on magnetic disk 112 is considerably larger than illustrated in FIG. 2.

FIG. 3 is a block diagram schematically illustrating components of PCB 200 from FIG. 1. PCB 200 includes a system-on-chip (SoC) 300, DRAM 202, which may be internal or external to SoC 300, flash memory 201, and a combo chip 203, which drives spindle motor 102 and arm actuator 105. Combo chip 203 also includes voltage regulators for SoC 300, pre-amplifier 107, and the motor controllers contained in SoC 300. As shown, flash memory 201 and DRAM 202 are coupled to SoC 300, which interfaces with the host via cable 110, pre-amplifier 107 via electrical connection 106, and combo chip 203 via serial bus 204. SoC 300 is an application-specific integrated circuit (ASIC) that includes a number of functional blocks designed to perform particular functions, such as a microcontroller configured to control the operation of disk drive 100, an input/output block, and an encryption/decryption block. Firmware for SoC 300 is stored in flash memory 201 and SoC 300 under firmware control generates random numbers according to one or more embodiments of the invention. In some embodiments, flash memory 201 resides in SoC 300. In alternative embodiments, a small portion of the firmware that is not changeable resides in a read-only memory within SoC 300 and the bulk of the firmware, including instructions for causing SoC 300 to generate random numbers in accordance with one or more embodiments of the invention, resides on magnetic disk 112 and is loaded shortly after power up of disk drive 100.

In operation, read/write head 104 in disk drive 100 reads data from or writes data to a specific concentric data storage track 242 of magnetic disk 112. The position of read/write head 104 continuously varies with respect to the centerline of the concentric data storage track 242 being followed. This variation is due, at least in part, to environmental factors, such as the temperature of magnetic disk 112, the air turbulence, atmospheric pressure and humidity of the interior of disk drive 100, and vibration of suspension arm 103 and media 112. Thus, the position error signal (PES) of read/write head 104 is due substantially to random effects and is a continuously varying number. Embodiments of the invention contemplate a method and system for generating random numbers in a disk drive, in which parity bits of successive PES samples are concatenated to quickly form a random number having a desired number of bits. Because PES is measured while the drive is track following as part of the normal operation of disk drive 100, no additional mechanical operations or specialized hardware is required to perform this method. Consequently, random numbers can be generated very quickly by disk drive 100 with no additional hardware or circuitry.

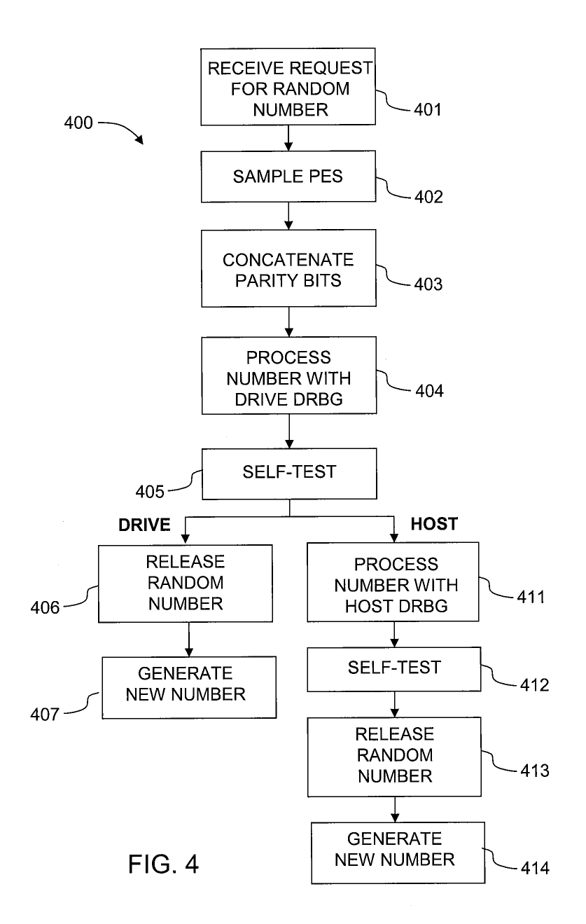

FIG. 4 is a flow diagram illustrating a method 400, according to an embodiment of the invention, for quickly generating a random number in a disk drive, wherein the random number is formed by concatenating the parity bits of multiple PES samples of the drive. For ease of description, method 400 is described in terms of a disk drive substantially similar to disk drive 100 in FIG. 1. In one embodiment, the commands for carrying out method 400 reside in the firmware for SoC 300.

In step 401, a request for a random number is received by the random number generation algorithm residing in the firmware of disk drive 100 from a caller. The caller may be an encryption algorithm residing in the firmware for SoC 300 or an application running on host 90, and the request may be for the purpose of generating random numbers for encryption algorithm or some other use. For example, one or more random numbers may be needed for use by disk drive 100 so that disk drive 100 can generate keys for encrypted communication with host 90 and/or for encrypting data received from host 90 that are to be stored in magnetic disk 112. The requested random number may be in the form of a very large number. For example, an RSA key in one embodiment may require numbers having 1024 to 4096 bits, and an AES key may require 256-bit numbers. In addition, an application on host 90 may ask for random numbers as small as 8-bits to as much as 32 kilobytes, in one embodiment.

In step 402, disk drive 100 samples the PES of read/write head 104 with respect to a particular concentric data storage track 242. In one embodiment, the particular concentric data storage track 242 used to sample PES is the concentric data storage track 242 over which read/write head 104 is currently positioned. Alternatively, upon receiving the request for a random number in step 401, disk drive 100 may perform the PES sampling of step 402 on a randomly determined concentric data storage track 242. In either case, each PES sample is a signed number quantifying position error of read/write head 104 relative to track center of the current track, and is represented by a series of bits, e.g., 16 bits, 32 bits, etc. The number of PES samples measured in step 402 may depend on the bit length of the random number requested in step 401, with one PES sample taken per bit. For example, 32 PES samples are taken in step 402 when a 32-bit random number is requested in step 401.

In step 403, the parity bits of multiple PES samples are concatenated to form a random number of the desired number of bits. As known in the art, the value of a parity bit is determined by summing the bits of a particular PES sample. If the sum is an even number, the value of the parity is 0, and if the sum is an odd number, the value of the parity is 1. Because each PES sample varies continuously and randomly due to environmental factors such as vibration, temperature, and atmospheric pressure, the value of each parity bit also varies randomly. Thus, by concatenating a plurality of random-value bits, i.e., the PES parity bits, a random number of any desired bit length may be generated. In one embodiment, a random number is formed in step 403 by concatenating the requisite number of PES parity bits in one step. For example, 128 PES samples are taken in step 402, and in step 403 128 parity bits are concatenated from the PES samples to generate a 128-bit number. In another embodiment, a random number is formed in step 403 by first forming smaller bit-length numbers, then assembling the smaller bit-length numbers to form a larger number. In this way, a single concatenation function can be used to assemble many different bit-length random numbers. For example, a series of four 32-bit numbers may be assembled to form a 128-bit random number, a series of eight 32-bit numbers may be assembled to form a 256-bit random number, etc.

Alternatively, one or more random numbers may be formed as described in steps 402-403 prior to receiving a request for a random number in step 401. In such an embodiment, the one or more random numbers are formed from concatenated parity bits as described above, but may be formed during normal operation of disk drive 100 and stored on magnetic disk 112, in flash memory 201, and/or in DRAM 202 for future use. In this way, a random number of the desired bit length may be provided by disk drive 100 very quickly, since PES sampling, parity bit calculation, and parity bit concatenation may be performed prior to the random number request in step 401. In one such embodiment, random numbers of various bit lengths are stored, e.g., 64-bit, 128-bit, 256-bit, etc. In another such embodiment, random numbers of a single bit length are stored, and are of a sufficiently small size, e.g., 32-bits, that these smaller bit-length numbers can be assembled into any larger size when disk drive 100 receives a random number request in step 401.

In step 404, the random number generated in step 403 is further processed by a deterministic random bit generator (DRBG). Various DRBGs are known in the art and are not described herein. The DRBG further randomizes the random number generated by steps 402-403. In addition, processing the random number generated in steps 402-403 with a DRBG produces a random number that can meet Federal Information Processing Standards (FIPS), since the source of entropy, i.e., the PES signal, is not used directly to produce a random number. In one embodiment, the amount of entropy fed to the DRBG, which is the random number generated in step 403, has the same bit length as the random number produced by the DRBG. Consequently, the security of the DRBG, which is not a truly random number generator, is significantly enhanced by maximizing the randomness of the DRBG input.

In step 405, the DRBG undergoes a self-test required for FIPS compliance. This self-test checks for situations where a number-generation algorithm has “hung-up” and is locked into a fixed state in which the same “random” number is generated over and over. As such, the random number generated in step 404 is compared with an immediately preceding random number generated by the DRBG.

FIG. 5 is a block diagram conceptually illustrating steps 404, 405, 406, and 407. First, the existing value in DRBG output buffer 560 is copied to caller buffer 570. Then, DRBG 550 generates a random number using concatenated parity bits 540 of PES samples as entropy input, and stores that random number in DRBG output buffer 560 (step 404). The values in the two buffers, namely DRBG output buffer 560 and caller buffer 570, are then compared (step 405). If the values are not different, self-test fails and host 90 is notified. If self-test passes, the value in DRBG output buffer 560 is copied into caller buffer 570 for use by an application (step 406). Then, DRBG 550 is called upon to generate a new random number and the new random number is held in DRBG output buffer 560 (step 407). One of skill in the art will appreciate that without generating the new random number and storing it in DRBG output buffer 560, the random number released for use by an application may remain stored in DRBG output buffer 560 for a long period of time, such as when no call for a random number has occurred for days or weeks, during which time the random number could be discovered.

Step 411 through 414 are carried out in lieu of steps 406 and 407 when the application requesting the random number is an application on host 90. First, the existing value in DRBG output buffer 565 is copied to caller buffer 575. Then, DRBG 555 generates a random number using the value stored in DRBG output buffer 560 as entropy input, and stores that random number in DRBG output buffer 565 (Step 411). The values in the two buffers, namely DRBG output buffer 565 and caller buffer 575, are then compared (Step 412). If the values are not different, self-test fails and host 90 is notified. If self-test passes, the value in DRBG output buffer 565 is copied into caller buffer 575 for use by caller 585 running in host 90 (Step 413). Then, DRBG 555 is called upon to generate a new random number and the new random number is held in DRBG output buffer 565 (Step 414). This depicts one possible configuration for supplying random numbers to a caller outside of the drive 100. It is also possible to configure DRBG 555 to accept entropy input directly from the output of 540 or some other source.

The DRBG used in step 411 (DRBG 550) has a different configuration compared to the DRBG used in step 404 (DRBG 555). This is because using the same algorithm to provide random numbers for generating encryption keys inside a drive that is used to provide random numbers to an external host can potentially compromise the security of the disk drive encryption keys. To with, a large sample of random numbers provided to a host may allow an outside party to detect weaknesses in the random number algorithm and/or to deduce characteristics of the algorithm that may greatly reduce the searching required to find a key. Embodiments of the invention contemplate the use of multiple DRBGs to prevent exposure of a disk drive encryption key algorithm while still allowing access to the PES-based entropy source by a host for random number generation.

Method 400 provides a means for quickly generating a random number in a disk drive. Because PES is a good source of entropy, i.e., randomness, and because PES is measured at a high sampling rate, method 400 can produce 1000s of truly random numbers per second. In addition, method 400 can be implemented entirely in the firmware of a disk drive, obviating the need for additional logic gates, registers, or other specialized hardware in the drive. Further, the source of entropy used in method 400 relies on information already available to the disk drive during normal use, so no additional mechanical operations or calculations are required that may slow the disk drive and/or erode the mechanical reliability of the drive.

While the foregoing is directed to embodiments of the present invention, other and further embodiments of the invention may be devised without departing from the basic scope thereof, and the scope thereof is determined by the claims that follow.

What is claimed is:

1. A method of generating one or more random numbers in a storage device comprising:
concatenating parity bits from a group of different position error signal samples to produce a random number.

2. The method according to claim 1, further comprising:
supplying the random number as entropy to a deterministic random number generator to produce a second random number.

3. The method according to claim 2, further comprising:
generating an encryption key using the second random number.

4. A method of generating first and second random numbers in a storage device comprising:
generating a first random number with a first deterministic random number generator;
storing the first random number for use by the storage device;
generating a second random number with a second deterministic random number generator; and
storing the second random number for use by a host connected to the storage device.

5. The method according to claim 4, wherein the first deterministic random number generator and the second deterministic random number generator have different configurations.

6. The method according to claim 4, wherein the first and second deterministic random number generators are supplied with the same source of entropy.

7. The method according to claim 4, wherein the first and second deterministic random number generators are supplied with different sources of entropy.

8. A method of responding to a random number request from an application, the method being carried out in a storage device having a random number stored therein, comprising:
generating a new random number;
comparing the new random number with the stored random number; and
if the two random numbers are not the same, supplying the new random number and not the stored random number to the requesting application.

9. A method of generating random numbers in a storage device having a first buffer and a second buffer, comprising:
generating a first random number with a deterministic random number generator using a first input as entropy and storing the first random number in the first buffer;
copying the first random number in the first buffer to the second buffer; and
generating a second random number with the deterministic random number generator using a second input as entropy and storing the second random number in the first buffer.

10. The method according to claim 9, further comprising:
concatenating parity bits from a first group of position error signal samples to produce the first input; and
concatenating parity bits from a second group of position error signal samples to produce the second input.

11. The method according to claim 9, further comprising:
comparing the first random number with a number stored in the second buffer while the first random number is stored in the first buffer.

12. The method according to claim 11, wherein the number stored in the second buffer is a random number previously generated by the deterministic random number generator but has not been used in any applications requiring a random number.

13. A storage device comprising:
a deterministic random number generator configured to receive N1 bits of entropy and generate N2 bits of a random number therefrom,
wherein N1 equals N2.

14. The storage device according to claim 13, further comprising:
a second deterministic random number generator configured to generate a third random number.

15. The storage device according to claim 14, wherein the N2 bits of the random number is supplied to an application of the storage device for use and the third random number is supplied to an application of a host connected to the storage device for use.

16. The storage device according to claim 15, wherein the two deterministic random number generators share a common entropy source.

17. The storage device according to claim 15, wherein the two deterministic random number generators have different entropy sources.

18. The storage device according to claim 13, further comprising:
a first memory buffer for storing the N2 bits of the random number generated by the deterministic random number generator; and
a second memory buffer from which a second random number copied from the first memory buffer is supplied to a requesting application.

19. The storage device according to claim 13, wherein
a non-deterministic random number generator configured to generate random numbers from parity bits extracted from multiple position error signal samples,
wherein the random numbers generated by the non-deterministic random number generator include the N1 bits of entropy.

20. The storage device according to claim 19, wherein the non-deterministic random number generator is configured to generate the random numbers by concatenating the extracted parity bits.
